(19) United States
(12) Patent Application Publication
(10) Pub. No.: US 2003/0125018 A1
(43) Pub. Date: Jul. 3, 2003

(54) Method and system for wireless-enabled teleconferencing with wireless data transmit and receive function

(76) Inventors: Cheng-Shing Lai, Taipei (TW); Jun Zhu, Nanjing (CN); Yongcai Bian, Nanjing (CN)

Correspondence Address: BIRCH STEWART KOLASCH & BIRCH, PO BOX 747, FALLS CHURCH, VA, 22040-0747, US

(21) Appl. No.: 10/329,690

(22) Filed: Dec. 27, 2002

(30) Foreign Application Priority Data
Dec. 31, 2001 (TW) 90133445

(51) Int. Cl. H04M 3/42; H04Q 7/20

(52) U.S. Cl. 455/416; 455/466

(57) ABSTRACT

Method and system for wireless-enabled teleconferencing with wireless data transmit and receive function. First, an audio communication channel between a request phone and a request gateway, between a response gateway and a response phone, and between the individual request and response gateways are established to begin a teleconference. Then, shared information is transmitted through the audio communication channel. After the teleconference ends, the audio communication channel is disconnected. Each of the request phone, the request gateway, the response gateway, and the response phone has a wireless communication module. Through the wireless communication module, the audio communication channel between the request phone and the request gateway, and between the response gateway and the response phone are established by means of the wireless communication protocol, and the audio communication channel between the request gateway and the response gateway is established though a network.

### BACKGROUND OF THE INVENTION

1. Field of the Invention

The invention relates to wireless communication, and more particularly to a method and system for wireless-enabled teleconferencing with wireless data transmit and receive function.

2. Description of the Related Art

At present, teleconferencing is widely used in government, public and private organizations decrease the communication costs and increase efficiency. Before teleconferencing, a system must be deployed by a telecommunication company to provide service, in which communication channels between participants are established, a frequently complex undertaking. Thus, after the teleconference begins, the participants must be in a fixed location, and shared information such as graphs, files, and images cannot be transmitted.

### SUMMARY OF THE INVENTION

An object of the present invention is to provide a method for wireless-enabled teleconferencing without confinement to a fixed area.

Another object of the present invention is to provide a wireless-enabled teleconferencing system with sharing of graphical and audio data.

Accordingly, the present invention provides a method for wireless-enabled teleconferencing. First, an audio communication channel between a request phone and a request gateway, between a response gateway and a response phone, and between the individual request and response gateways are established to begin a teleconference. Then, shared information is transmitted through the audio communication channel. After the teleconference ends, the audio communication channel is disconnected. Each of the request phone, the request gateway, the response gateway and the response phone has a wireless communication module. The audio communication channel between the request phone and the request gateway, and between the response gateway and the response phone are established by means of the wireless communication protocol, and the audio communication channel between the request gateway and the response gateway is established though a network.

Furthermore, the present invention also provides a wireless-enabled teleconferencing system. The teleconferencing system comprises a computer, a phone, and a gateway. The phone is coupled to the computer. The phone comprises a wireless communication module, and a communication port for transmitting data to the computer and receiving data from the computer. The gateway comprises a wireless communication module, an audio communication port, and a data communication port. The audio communication port is coupled to an audio network through a telephone line. The data communication port is coupled to a data network through a network line. Through the wireless communication module, shared information is transmitted between the phone and the gateway. When the shared information is data, the gateway transmits the data transmitted from the phone to the data network and the data transmitted from the data network to the phone. When the shared information is audio data, the gateway transmits the audio data from the phone to the audio network and from the audio network to the phone.

### DESCRIPTION OF THE DRAWINGS

For a better understanding of the present invention, reference is made to a detailed description to be read in conjunction with the accompanying drawings, in which:

FIG. 1 is a schematic illustrating network topology of a teleconferencing system according to the embodiment of the invention;

FIG. 2a is a flowchart illustrating the procedure for establishing an audio communication channel in the request gateway;

FIG. 2b is a flowchart illustrating the procedure for establishing an audio communication channel in the request phone;

FIG. 2c is a flowchart illustrating the procedure for establishing an audio communication channel in the response gateway;

FIG. 2d is a flowchart illustrating the procedure for establishing an audio communication channel in the response phone;

FIG. 3a is a flowchart illustrating the procedure for transmitting shared information in the request gateway;

FIG. 3b is a flowchart illustrating the procedure for transmitting shared information in the request phone;

FIG. 3c is a flowchart illustrating the procedure for transmitting shared information in the response gateway;

FIG. 3d is a flowchart illustrating the procedure for transmitting shared information in the response phone; and

FIG. 4 is a flowchart illustrating the procedure for disconnecting the audio communication channel.

### DETAILED DESCRIPTION OF THE INVENTION

The present invention implements a method and system for wireless-enabled teleconferencing.

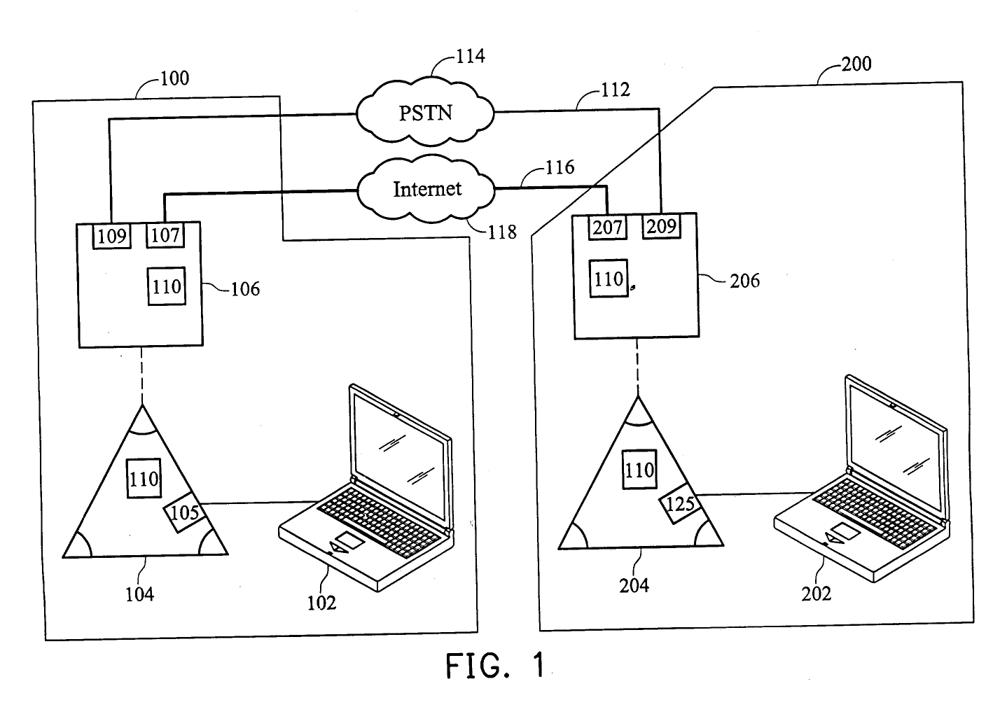

FIG. 1 is a schematic illustrating a network topology of a teleconferencing system according to the embodiment of the invention. Two teleconferencing systems are shown in FIG. 1. One is a local teleconferencing system 100. The other is a remote teleconferencing system 200. The public switcher telephone network (PSTN) 114 and Internet 118 connect the local teleconferencing system 100 to the remote teleconferencing system 200. In the embodiment, a teleconference is originated by the local teleconferencing system 100, referred to as the request teleconferencing system. Next, the remote teleconferencing system 200, referred to as the response teleconferencing system, responds to the teleconference begin signal, and the teleconference between the local teleconferencing system 100 and the remote teleconferencing system 200 begins.

The local teleconferencing system 100 comprises a phone 104 and a gateway 106, both with wireless communication modules 110. After an audio communication channel is established between the phone 104 and gateway 106, the phone 104 and the gateway 106 form a local wireless network through the wireless communication module 110. In the local wireless network, the gateway 106 is a master device and the phone 104 is a slave device. Through the wireless communication module 110, the phone 104 communicates with the gateway 106. The phone 104 further comprises a communication port 105. The communication port 105 is connected to a notebook 102. The communication port 105 transmits data to and receives data from the notebook 102. The gateway further comprises a data communication port 107 and an audio communication port 109. The data communication port 107 is coupled to the Internet 118 through a network line 116. The audio communication port 109 is coupled to PSTN 114 through a telephone line 112.

The remote teleconferencing system 200 comprises a phone 204 and a gateway 206, both with wireless communication modules 110. After an audio communication channel is established between the phone 204 and gateway 206, the phone 204 and the gateway 206 form a local wireless network through the wireless communication module 110. In the local wireless network, the gateway 206 is a master terminal and the phone 204 is a slave terminal. Through the wireless communication module 110, the phone 204 communicates with the gateway 206. The phone 204 further comprises a communication port 205. The communication port 105 is connected to a notebook 202. The communication port 205 transmits data to the notebook 202 and receives data from the notebook 102. The gateway further comprises a data communication port 207 and an audio communication port 209. The data communication port 207 is coupled to the Internet 118 through a network line 116. The audio communication port 209 is coupled to the PSTN 114 through a telephone line 112.

In addition to the audio communication channel between the phone 104 and the gateway 106, and the gateway 206 and the phone 204, the audio communication channel must also be established between the gateway 106 and the gateway 206 to begin the teleconference. After the teleconference begins, shared information is transmitted between the phone 104 and the gateway 106, and between the gateway 206 and the phone 204. The shared information may be graphical or audio data.

When the shared information is graphical, the gateway 106 transmits the data from the phone 104 to the Internet 118. The gateway 206 receives the data from the Internet 118 and transmits the data to the phone 204. Similarly, the gateway 206 also transmits the data from the phone 204 to the Internet 118. The gateway 106 receives the data from the Internet 118 and transmits the data to the phone 104.

When the shared information is audio data, the gateway 106 transmits the audio data from the phone 104 to the PSTN 114. The gateway 206 receives the audio data from the PSTN 114 and transmits the audio data to the phone 204. Similarly, the gateway 206 also transmits the audio data from the phone 204 to the PSTN 114. The gateway 106 receives the audio data from the PSTN 114 and transmits the audio data to the phone 104.

In the embodiment of the present invention, using different networks to transmit shared information improves the communication quality. In the configuration of the above embodiment, the Internet 1.18 can be replaced with other data networking such as asymmetric digital subscriber line or other broadband network. The notebooks 102 and 202 can be replaced with other type of computer such as personal digital assistant or personal computer.

The method for the teleconference to realize wireless communication follows. A request phone, a request gateway, a response phone and a response gateway in the following description are collectively represented by the phone 104, the gateway 106, the phone 204 and the gateway 206 in FIG. 1.

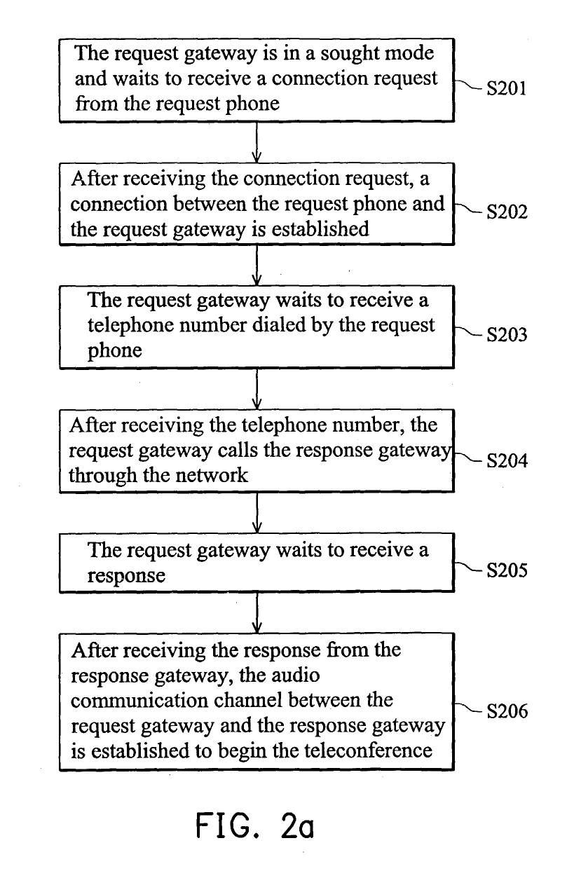

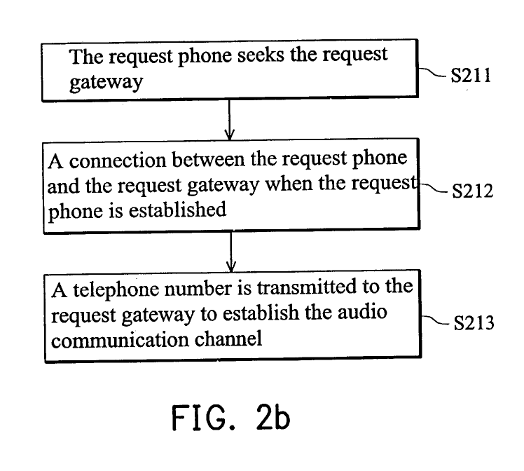

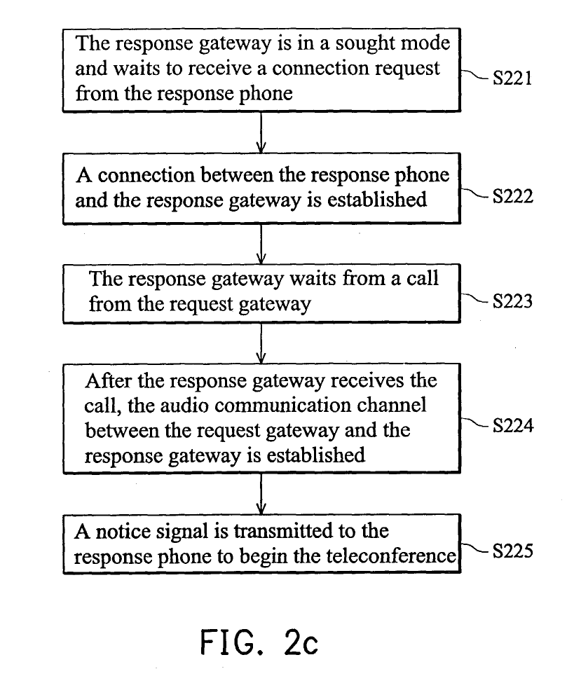

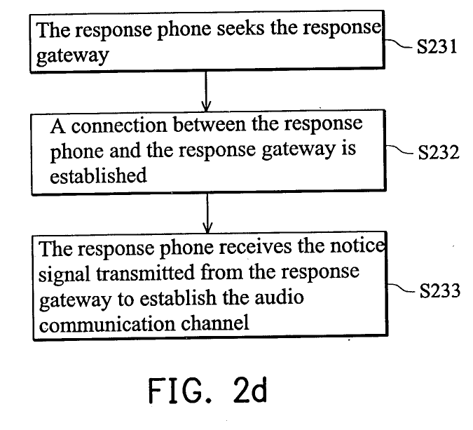

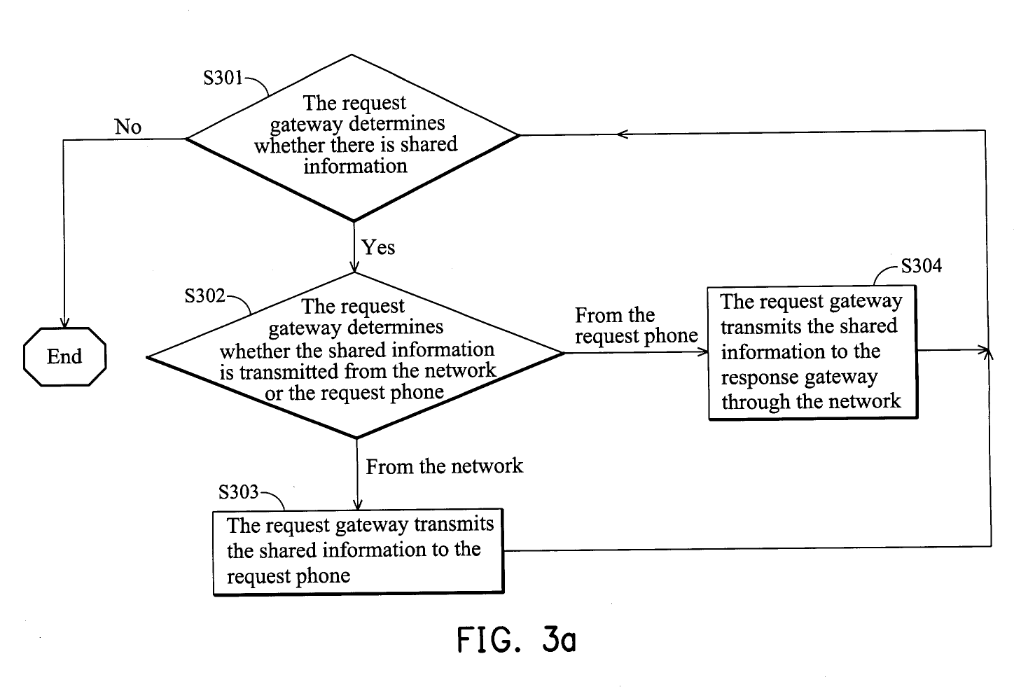

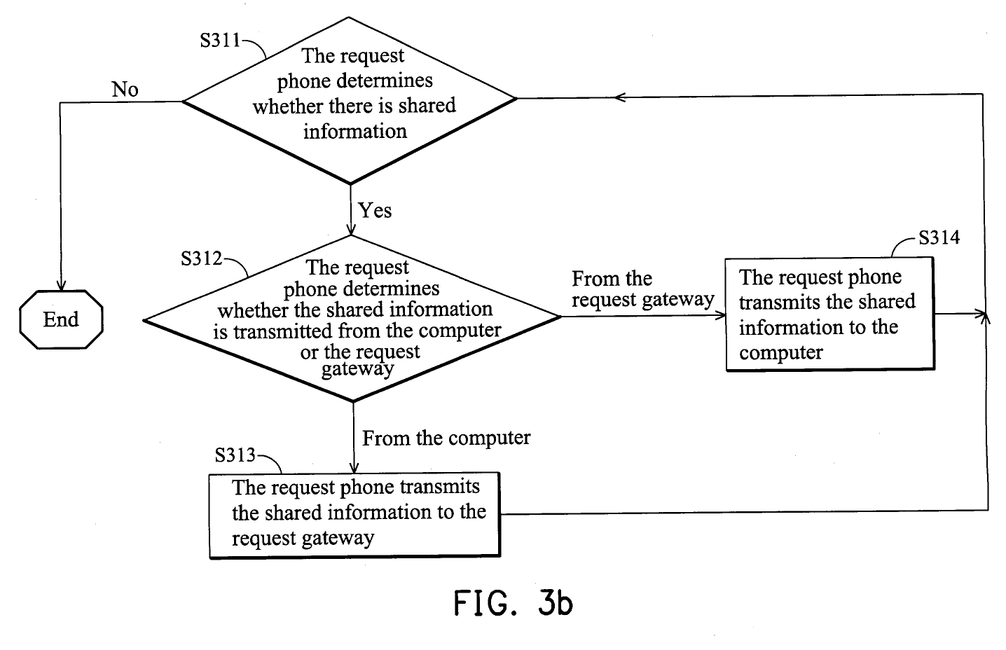

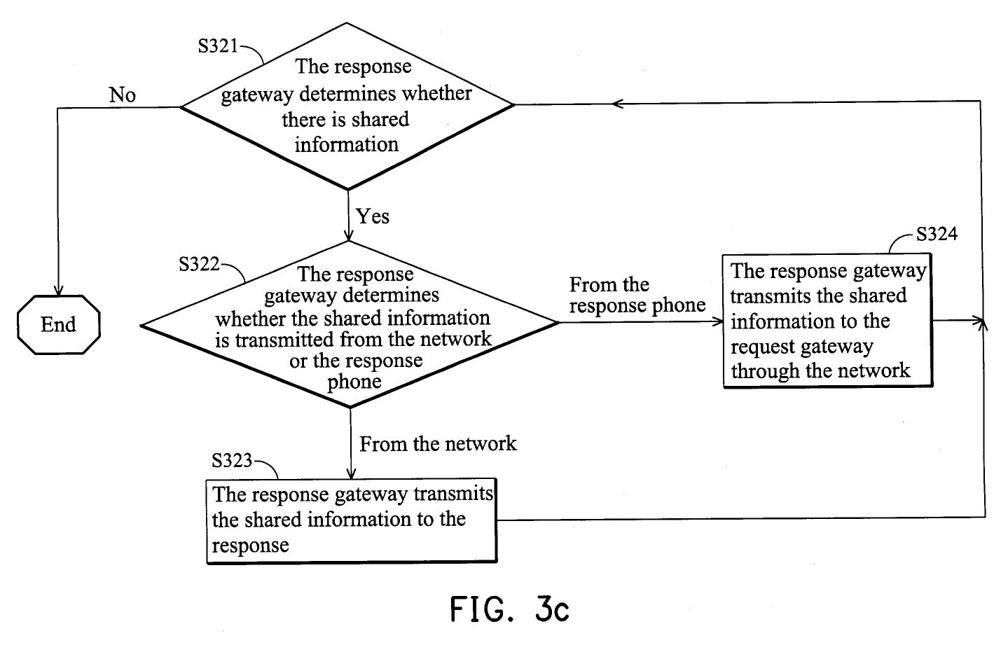

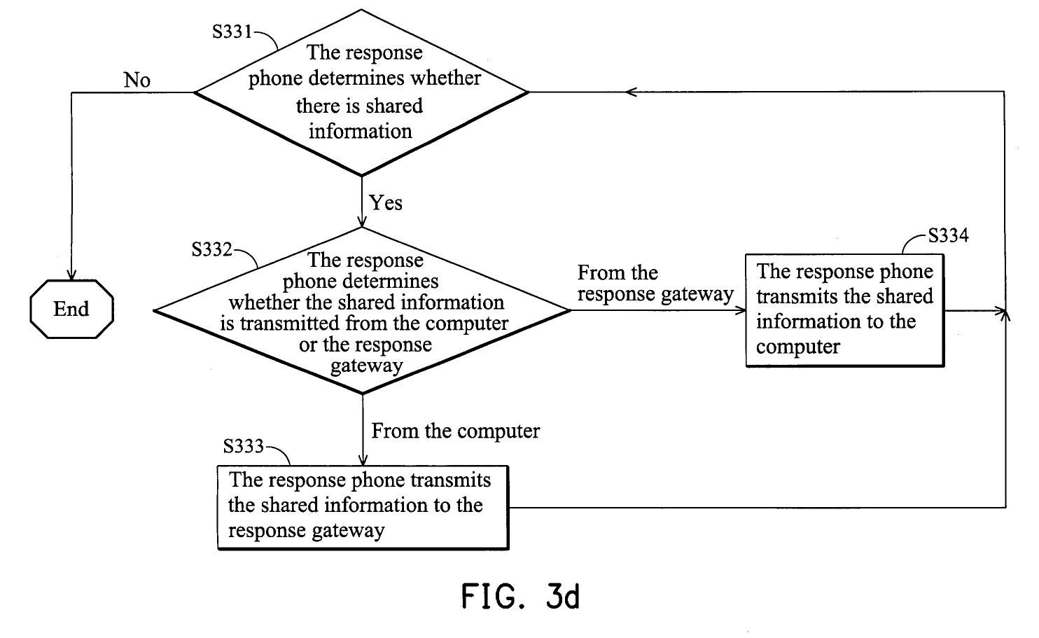

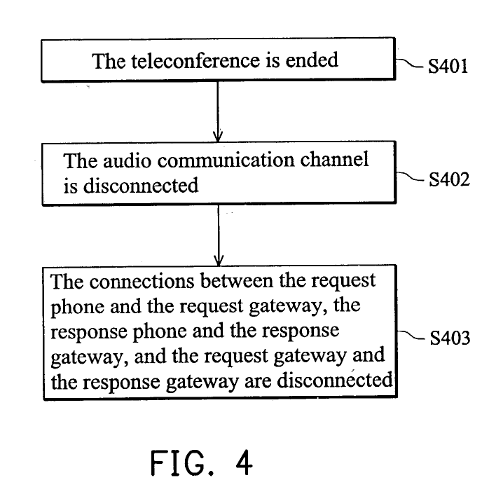

First, an audio communication channel between a request phone and a request gateway, between a response gateway and a response phone, and between the individual request and response gateways are established to begin a teleconference. FIG. 2a, FIG. 2b, FIG. 2c and FIG. 2d are flowcharts illustrating the procedure for establishing the audio communication channel. Then, shared information is transmitted through the audio communication channel at the teleconference. A full-duplex method is implemented to transmit shared information in the audio communication channel. FIG. 3a, FIG. 3b, FIG. 3c and FIG. 3d are flowcharts illustrating the procedure for transmitting shared information. After the teleconference ends, the audio communication channel is disconnected. FIG. 4 is a flowchart illustrating the procedure for disconnecting the audio communication channel.

FIG. 2a is a flowchart illustrating the procedure for establishing an audio communication channel in the request gateway. First, the request gateway is in a sought mode and waits to receive a connection request from the request phone (S201). After receiving the connection request, a connection between the request phone and the request gateway is established (S202). Then, the request gateway waits to receive a telephone number dialed by the request phone (S203). After receiving the telephone number, the request gateway calls the response gateway through the network (S204). Then, the request gateway waits to receive a response (S205). After receiving the response from the response gateway, the audio communication channel between the request gateway and the response gateway is established to begin the teleconference (S206).

FIG. 2b is a flowchart illustrating the procedure for establishing an audio communication channel in the request phone. First, the request phone seeks the request gateway (S211). Next, a connection between the request phone and the request gateway when the request phone is established (S212). Finally, a telephone number is transmitted to the request gateway to establish the audio communication channel (S213).

FIG. 2c is a flowchart illustrating the procedure for establishing an audio communication channel in the response gateway. The response gateway is in a sought mode and waits to receive a connection request from the response phone (S221). Next, a connection between the response phone and the response gateway is established (S222). Then, the response gateway waits from a call from the request gateway (S223). After the response gateway receives the call, the audio communication channel between the request gateway and the response gateway is established (S224). Finally, a notice signal is transmitted to the response phone to begin the teleconference (S225).

FIG. 2d is a flowchart illustrating the procedure for establishing an audio communication channel in the response phone. First, the response phone seeks the response gateway (S231). Next, a connection between the response phone and the response gateway is established (S232). Finally, the response phone receives the notice signal transmitted from the response gateway to establish the audio communication channel (S233).

FIG. 3a is a flowchart illustrating the procedure for transmitting shared information in the request gateway. First, the request gateway determines whether there is shared information (S301). If not, the procedure is ended. If so, the request gateway determines whether the shared information is transmitted from the network or the request phone (S302). If from the network, the request gateway transmits the shared information to the request phone (S303). If from the request phone, the request gateway transmits the shared information to the response gateway through the network (S304).

FIG. 3b is a flowchart illustrating the procedure for transmitting shared information in the request phone. First, the request phone determines whether there is shared information (S311). If not, the procedure is ended. If so, the request phone determines whether the shared information is transmitted from the computer or the request gateway (S312). If from the computer, the request phone transmits the shared information to the request gateway (S313). If from the request gateway, the request phone transmits the shared information to the computer (S314).

FIG. 3c is a flowchart illustrating the procedure for transmitting shared information in the response gateway. First, the response gateway determines whether there is shared information (S321). If not, the procedure is ended. If so, the response gateway determines whether the shared information is transmitted from the network or the response phone (S322). If from the network, the response gateway transmits the shared information to the response phone (S323). If from the response phone, the response gateway transmits the shared information to the request gateway through the network (S324).

FIG. 3d is a flowchart illustrating the procedure for transmitting shared information in the response phone. First, the response phone determines whether there is shared information (S331). If not, the procedure is ended. If so, the response phone determines whether the shared information is transmitted from the computer or the response gateway (S332). If from the computer, the response phone transmits the shared information to the response gateway (S333). If from the response gateway, the response phone transmits the shared information to the computer (S334).

FIG. 4 is a flowchart illustrating the procedure for disconnecting the audio communication channel. First, the teleconference is ended (S401). Then, the audio communication channel is disconnected (S402). The connections between the request phone and the request gateway, the response phone and the response gateway, and the request gateway and the response gateway are disconnected (S403).

The advantage of the present invention provision of a wireless-enabled teleconferencing system without confinement to a fixed field, and the ability to share graphical and audio data during the teleconference.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for wireless-enabled teleconferencing, comprising:
establishing an audio communication channel between a request phone and a request gateway, between a response gateway and a response phone, and between the individual request and response gateways to begin a teleconference;
transmitting shared information through the audio communication channel; and
disconnecting the audio communication channel when the teleconference ends;
wherein each of the request phone, the request gateway, the response gateway and the response phone has a wireless communication module; through the wireless communication module, the audio communication channel between the request phone and the request gateway, and between the response gateway and the response phone is established; and the audio communication channel between the request gateway and the response gateway is established though a network.

2. The method of claim 1, wherein establishing an audio communication channel in the request gateway further comprises:
receiving a connection request from the request phone when the request gateway is in a sought mode;
establishing a connection between the request phone and the request gateway;
receiving a telephone number dialed by the request phone;
using the telephone number, calling the response gateway through the network;
receiving a response from the response gateway; and
establishing the audio communication channel between the request gateway and the response gateway to begin the teleconference.

3. The method of claim 1, wherein establishing an audio communication channel in the request phone further comprises:
seeking the request gateway;
establishing a connection between the request phone and the request gateway when the request phone seeks the request gateway; and
transmitting a telephone number to the request gateway with which to establish the audio communication channel.

4. The method of claim 1, wherein establishing an audio communication channel in the response gateway further comprises:
receiving a connection request from the response phone when the response gateway is in a sought mode;
establishing a connection between the response phone and the response gateway;
receiving a call made by the request gateway;
establishing the audio communication channel between the request gateway and the response gateway;
and
transmitting a notice signal to the response phone to begin the teleconference.

5. The method of claim 1, wherein establishing an audio communication channel in the response phone further comprises:
seeking the response gateway;
establishing a connection between the response phone and the response gateway when the response phone seeks the response gateway; and
receiving a notice signal transmitted from the response gateway to establish the audio communication channel.

6. The method of claim 1, wherein transmitting shared information in the request gateway further comprises:
determining whether there is shared information needed to be received;
when receiving the shared information, determining whether the shared information is transmitted from the network or the request phone;
when the shared information is transmitted from the network, transmitting the shared information to the request phone; and
when the shared information is transmitted from the request phone, transmitting the shared information to the response gateway through the network.

7. The method of claim 1, wherein transmitting shared information in the request phone further comprises:
determining whether there is shared information needed to be received;
when the request phone receives the shared information, determining whether the shared information is transmitted from the computer or the request gateway;
when the shared information is transmitted from a computer, transmitting the shared information to the request gateway; and
when the shared information is transmitted from the request gateway, transmitting the shared information to the computer.

8. The method of claim 7, wherein the computer is a personal digital assistant coupled to the request phone to store the shared information.

9. The method of claim 7, wherein the computer is a notebook coupled to the request phone to store the shared information.

10. The method of claim 7, wherein the computer is a personal computer coupled to the request phone to store the shared information.

11. The method of claim 1, wherein transmitting shared information in the response gateway further comprises:
determining whether there is shared information needed to received;
when the response gateway receives the shared information, determining whether the shared information is transmitted from the network or the response phone;
when the shared information is transmitted from the network, transmitting the shared information to the response phone; and
when the shared information is transmitted from the response phone, transmitting the shared information to the request gateway through the network.

12. The method of claim 1, wherein transmitting shared information in the response phone further comprises:
determining whether there is shared information needed to be received;
when the response phone receives the shared information, transmitting the shared information from the computer or the request gateway;
when the shared information is transmitted from a computer, transmitting the shared information to the response gateway; and
when the shared information is transmitted from the response gateway, transmitting the shared information to the computer.

13. The method of claim 12, wherein the computer is a personal digital assistant coupled to the response phone to store the shared information.

14. The method of claim 12, wherein the computer is a notebook coupled to the response phone to store the shared information.

15. The method of claim 12, wherein the computer is a personal computer coupled to the response phone to store the shared information.

16. The method of claim 1, wherein disconnecting the audio communication channel further comprises disconnecting a plurality of connections between the request phone and the request gateway, the response phone and the response gateway, and the request gateway and the response gateway.

17. The method of claim 1, wherein a full-duplex method is implemented to transmit shared information in the audio communication channel.

18. The wireless-enabled teleconferencing method of claim 1, wherein the wireless communication module utilizes at least the Bluetooth wireless communication protocol.

19. A wireless-enabled teleconferencing system, comprising:
a computer;
a phone coupled to the computer, comprising:
a wireless communication module; and
a communication port for transmitting data to the computer and receiving data from the computer;
and
a gateway, comprising:
a wireless communication module;
an audio communication port coupled to an audio network through a telephone line; and
a data communication port coupled to a data network through a network line;
wherein, through the wireless communication module, shared information is transmitted between the phone and the gateway; wherein, when the shared information is data, the gateway transmits the data from the phone to the data network and the data is transmitted from the data network to the phone; and when the shared information is audio data, the gateway transmits the audio data from the phone to the audio network and from the audio network to the phone.

20. The teleconferencing system of claim 19, wherein the audio network is a public switched telephone network.

21. The teleconferencing system of claim 19, wherein the data network is an asymmetric digital subscriber line network.

22. The teleconferencing system of claim 19, wherein the data network is Internet.

23. The teleconferencing system of claim 19, wherein the computer is a personal digital assistant coupled to the phone to store the shared information.

24. The teleconferencing system of claim 19, wherein the computer is a notebook coupled to the phone to store the shared information.

25. The teleconferencing system of claim 19, wherein the computer is a personal computer coupled to the phone to store the shared information.

26. The wireless-enabled teleconferencing system of claim 19, wherein the wireless communication module utilizes at least the Bluetooth wireless communication protocol.
